(19) United States
(12) Patent Application Publication
(10) Pub. No.: US 2007/0096489 A1
(43) Pub. Date: May 3, 2007

(54) Hinge structure of glove box for vehicle

(76) Inventor: Woo Chul Park, Suwon-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/300,155

(22) Filed: Dec. 13, 2005

(30) Foreign Application Priority Data
Nov. 2, 2005 (KR) 2005-0104559

(51) Int. Cl. B60R 7/06

(52) U.S. Cl. 296/37.12

(57) ABSTRACT

Disclosed is a hinge structure of a glove box for a vehicle. When pivot force is induced in the glove box by the weight of the glove box at the time of opening the glove box, the hinge structure provides pivotal frictional force produced hinged areas without employing a separate air damper, so that the pivot speed of the glove box can be reduced. As a result the glove box can be smoothly opened so as to prevent or substantially reduce the noise produced when the glove box is abruptly opened, thereby enhancing the commercial value of the resultant article.

### CROSS-REFERENCE TO RELATED APPLICATION

This application claims priority to and the benefit of Korean Patent Application 2005-0104559 filed in the Korean Intellectual Property Office on Nov. 2, 2005, the entire content of which is incorporated by reference herein.

### FIELD OF THE INVENTION

The present invention relates to a hinge structure of a glove box for a vehicle, and in particular to a hinge structure of a glove box for a vehicle, in which, when the glove box pivots, elastic yokes are engaged with and deformed by oval hinge-braking portions, thereby increasing the frictional force between the elastic yokes and the hinge-braking portions, so that the pivot speed of the grove box can be controlled.

### DESCRIPTION OF THE PRIOR ART

Typically, a glove box of a vehicle is installed on an instrument panel in front of the assistant's seat of the vehicle to be pivotally opened and closed, so that various small articles can be received in the glove box for the convenience of a passenger or a driver.

As shown in FIG. 1, such a glove box 1 is configured in the form of a top-opened receiving cavity, wherein a closure 2 is integrally formed with the front side of the glove box, and a pair of hinge joints 5 are provided at the opposite sides of the lower edge of the glove box, respectively, thereby pivotally supporting the glove box 1.

With the glove box 1 configured as described above, if the closure 2 is slightly pushed, a locking device 3 is released, so that the glove box 1 is pivoted about the hinge joints 5 provided at the lower edge thereof, thereby being opened. In the opened state, if the closure 2 is pushed again, the glove box 1 is pivoted about the hinge joints 5 and the closure 2 comes into contact with the opening of the instrument panel 7, so that the closure 2 is secured by the locking device 3.

As a result, the receiving cavity of the glove box 1 is received in the instrument panel 7 and the articles contained and stored in the receiving cavity are concealed, whereby the inner space of the vehicle can be put in order.

As shown in the drawing, an air damper 6, which has been employed for opening and closing such a glove box 1, has a hollow cylinder 6-1, a piston 6-2 fitted in the cylinder 6-1, a wire holder 6-3 inserted in one end of the piston 6-2, and a through-hole 64 formed at the center of the wire holder 6-3.

In addition, one end of a wire 6-5 is inserted in the through-hole 64 of the wire holder 6-3 and anchored by an anchoring piece 6-6 provided at the one end of the wire 6-5, and the other end of the wire 6-5 is drawn out to the outside of the air damper 6 and connected to the rear plate 4 of the glove box 4.

The air damper 6 is secured to the instrument panel 7 by a bracket 6-8 formed at the lower side of the air damper 6.

Meanwhile, the other end of the piston 6-2 is formed with an air passage 6-7, so that the opening velocity of the glove box I can be controlled by the flow rate of the surrounding air flown into the inner side of the cylinder 6-1 through the air passage 6-7.

That is, the air damper 6 renders the glove box 1 to be slowly opened by decreasing the flow rate of the air flown into the cylinder 6-1 through the air passage 6-7 of the piston.

Consequently, it is intended to prevent the glove box 1 from being damaged when the glove box 1 is abruptly opened or closed, thereby protecting the articles contained in the glove box 1.

For this purpose, the air damper 6 is installed at the rear side or the lateral side of the glove box 1 in order to control the pivoting velocity of the glove box 1. However, there is a disadvantage in that the installation of the air damper 6 contributes to poor assemblage of the glove box 1 and increases the manufacturing costs.

Furthermore, if such an air damper is optional and thus a vehicle is not provided with such an air damper, there is a problem in that it is impossible to prevent the noise generated when the glove box of the vehicle is abruptly opened and dropped under the influence of its self-weight when the vehicle is sharply turned or abruptly decelerated.

### SUMMARY OF THE INVENTION

Accordingly, the present invention has been made to solve the above-mentioned problems occurring in the prior art, and an object of the present invention is to provide a hinge structure which employs elastic yokes, a glove box housing, and a hinge locking pin with anchoring parts and O-rings, without employing a separate air damper, so that when the glove box is caused to pivot by its self-weight, pivotal friction is generated in hinge units, thereby reducing the pivot speed of the glove box without being assisted any other means, as a result of which the glove box can be smoothly opened when it is desired to open the glove box.

In order to achieve the above-mentioned object, there is provided a hinge structure of a glove box for a vehicle comprising: a grove box housing; a hinge locking pin assembled with the glove box housing so as to serve as a pivot axis for the glove box housing; a pair of hinge units fitted on the left and right halves of the hinge locking pin, respectively so as to hingedly intermit the glove box housing; and elastic yokes inserted and removably secured in engagement holes, which are formed in the hinge units, respectively. The hinge locking pin may have an escape prevention ridge and a handle at one end thereof and a catching ridge and a slit at the other end.

According to an embodiment of the present invention, the elastic yokes are individually provided at top and bottom sides of the left and right halves of the hinge locking pin.

According to another embodiment of the present invention, each elastic yoke has at least one projection formed in a shape of a semi-circle at the central part thereof with the rear side of the projection being concavely formed in a corresponding shape.

According to another embodiment of the present invention, the hinge locking pin is provided with catching portions at the areas to be engaged with the elastic yokes.

According to another embodiment of the present invention, each catching portion has an oval shape in cross-section.

According to another embodiment of the present invention, the hinge structure may further comprise O-rings so as to prevent a gap from being formed between the glove box housing and the hinge locking pin when the glove box housing pivots.

Still, according to another embodiment of the present invention, the O-rings may be formed from silicon.

Furthermore, the O-rings are provided at the opposite sides of the glove box housing, respectively.

### BRIEF DESCRIPTION OF THE DRAWINGS

The above and other objects, features and advantages of the present invention will be more apparent from the following detailed description taken in conjunction with the accompanying drawings, in which:

FIG. 1 is a cross-sectional view showing an air damper of a conventional glove box for a vehicle;

FIG. 2 is an exploded perspective view showing the inventive hinge structure of a glove box for a vehicle;

FIG. 3 is a perspective view showing the inventive hinge structure of a glove box for a vehicle in the assembled state;

FIG. 4 is an enlarged perspective view of portion “A” in FIG. 3;

FIGS. 5a and 5b are cross-sectional views showing different embodiments for the elastic yokes of the inventive hinge structure of a glove box for a vehicle, respectively;

FIG. 6 is a cross-sectional view showing a variant embodiment for the elastic yokes of the inventive hinge structure of a glove box for a vehicle;

FIG. 7 is a graph showing the relationship between the pivot angle and the pivotal frictional force when the inventive glove box is opened; and

FIGS. 8a to 8c are views showing the operating states of the inventive hinge structure of a glove box for a vehicle.

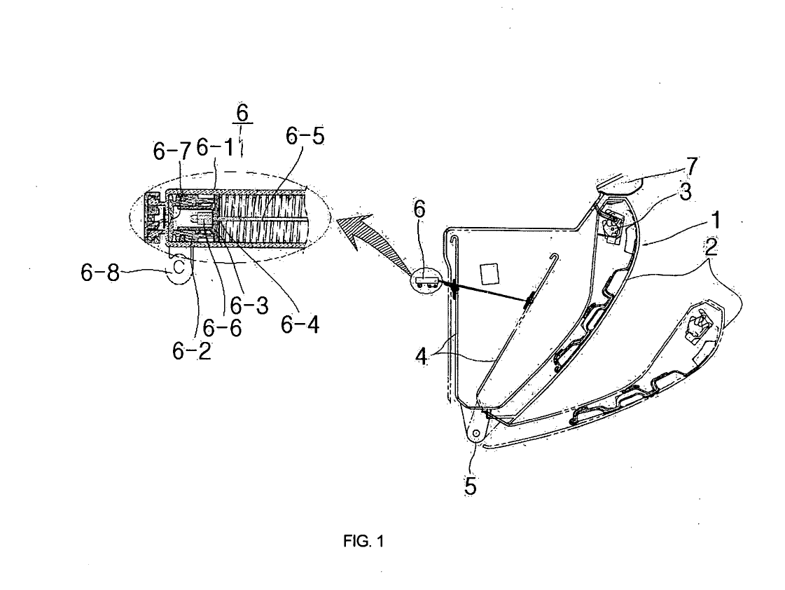

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, so that repeated description on the same or similar components will be omitted.

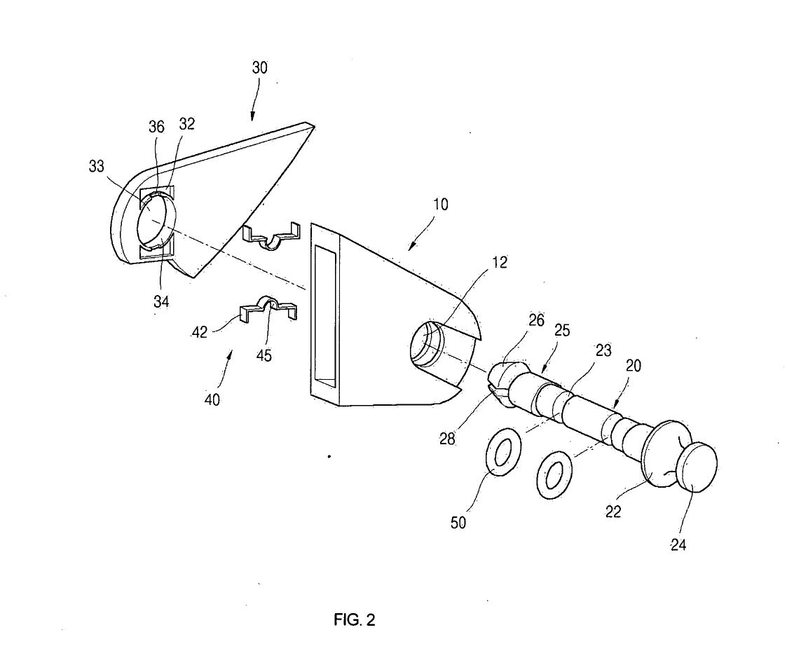

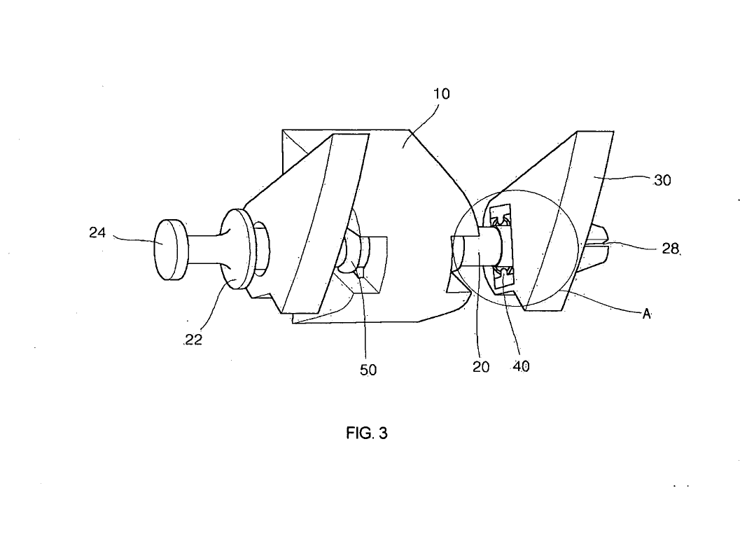

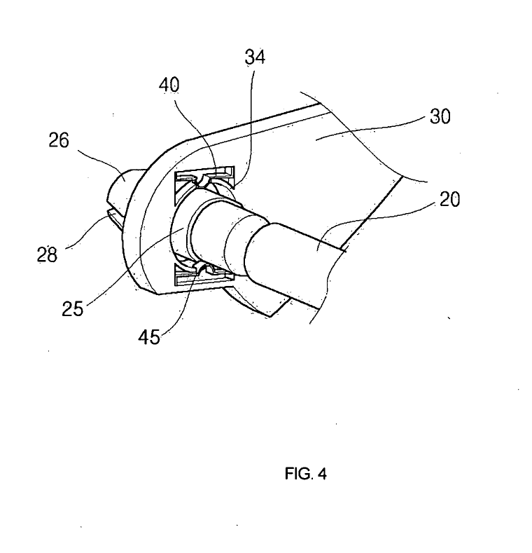

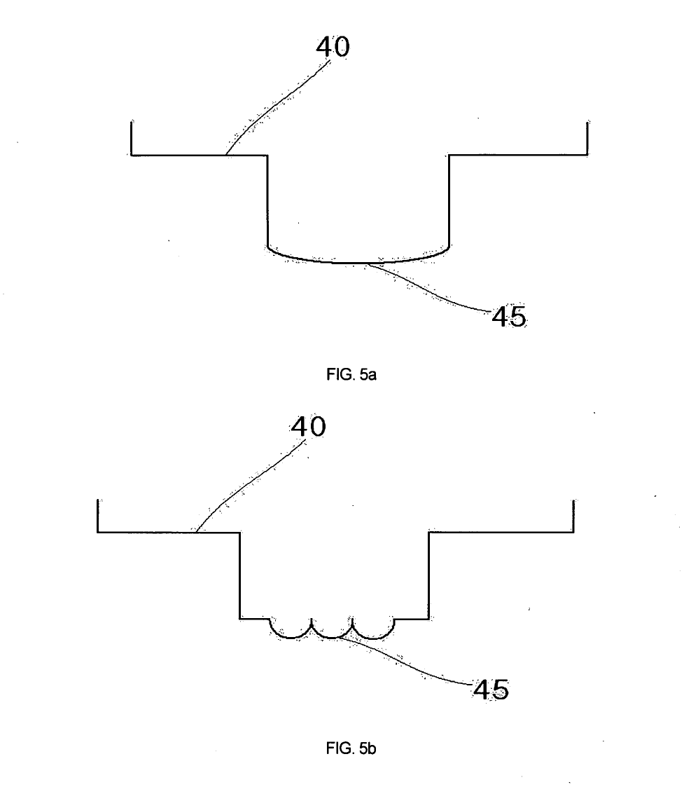

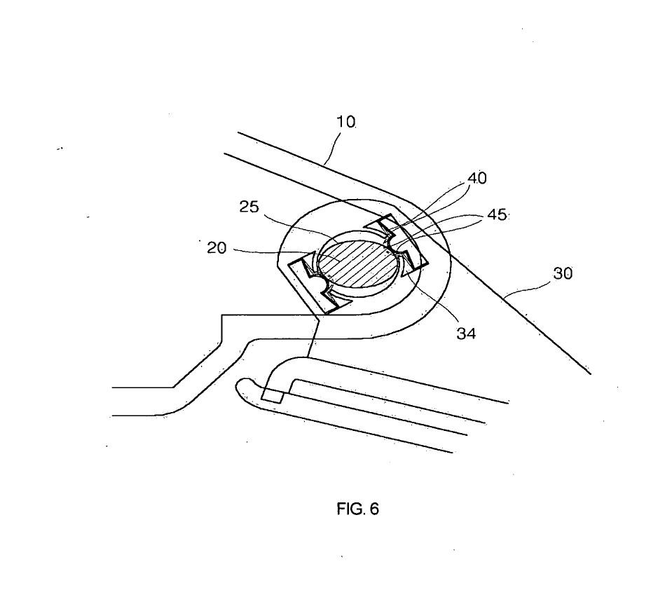

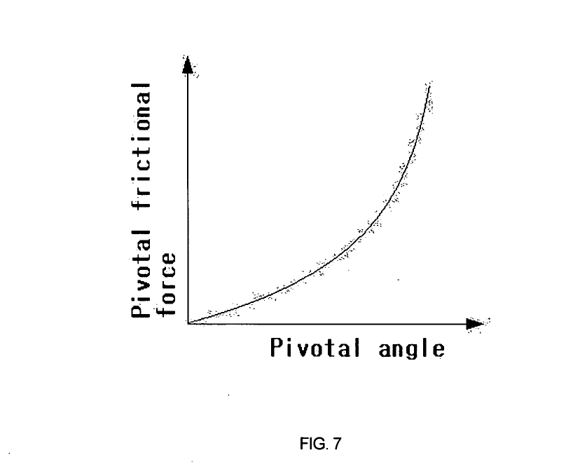

FIG. 2 is an exploded perspective view showing the inventive hinge structure of a glove box for a vehicle; FIG. 3 is a perspective view showing the inventive hinge structure of a glove box for a vehicle in the assembled state; FIG. 4 is an enlarged perspective view of portion “A” in FIG. 3; FIGS. 5a and 5b are cross-sectional views showing different embodiments for the elastic yokes of the inventive hinge structure of a glove box for a vehicle, respectively; FIG. 6 is a cross-sectional view showing a variant embodiment for the elastic yokes of the inventive hinge structure of a glove box for a vehicle; and FIG. 7 is a graph showing the relationship between the pivot angle and the pivotal frictional force when the inventive glove box is opened.

As shown in FIGS. 2 to 4, the inventive hinge structure of a glove box for a vehicle comprises a glove box housing 10, a hinge locking pin 20, hinge units 30, elastic yokes 40, and O-rings 50.

The glove box housing 10 is formed with a through-hole 12 and assembled with the hinge locking pin 20 fitted in the through-hole 20, wherein the hinge locking pin 20 serves as a pivot axis when the closure (not shown) of the glove box is opened or closed.

When the glove box housing 10 and the hinge locking pin 20 are assembled with each other, it is necessary to make them tightly engaged with each other, so that the hinge locking pin 20 cannot be moved with respect to the glove box housing 10.

The hinge locking pin 20, which is assembled with the glove box housing 10 to serve as the pivot axis of the glove box housing, is provided with an escape prevention ridge 22 and a handle 24, which allows a user to perform an operation for assembling the hinge locking pin 20 with the glove box housing 10.

The other end of the hinge locking pin 20 is provided with a catching ridge 26, which is engaged with a hinge unit 30 so as to prevent the hinge unit 30 from escaping, and a slit 28, which is formed in a predetermined depth and diametrically through the catching ridge 26.

The catching ridge 26 is formed in a radially divergent shape.

Therefore, the catching ridge 26 can be elastically retracted or expanded due to the slit 28 and makes it easy to fit the hinge locking pin 20 into the through-hole 12 formed in the glove box housing 10 by being retracted when the hinge locking pin 20 is pushed through the through-hole 12 so as to assembly the hinge locking pin 20.

After the locking pin 20 is assembled with the glove box housing 10, the catching ridge 26 is returned to its original state beyond the periphery of the through-hole 12, thereby preventing the escape of the glove box housing 10.

The left and right halves of the hinge locking pin 20 are respectively formed with catching portions 25 each in an oval shape in cross-section, at the areas, on which the elastic yokes 40 to be described later will be engaged with the hinge locking pin 20.

Therefore, when the glove box housing 10 is opened, the glove box housing 10 pivots in the state in which the elastic yokes 40 are engaged with the catching portions 25, so that the pivot speed of the glove box housing 10 rendered by its self-weight is reduced, whereby the glove box housing 10 can be smoothly opened.

Two insertion grooves 23 are formed on the hinge locking pin 20.

An O-ring 50 is inserted into each insertion groove 23, so that no gap can be produced between the glove box housing 10 and the hinge locking pin 20 when the glove box housing 10 pivots.

The hinge units 30 are fitted on the catching portions 25 of the hinge locking pin 20, respectively, wherein each hinge unit 30 comprises a second through-hole 33, the radius of which corresponds to the long radius of the catching portions 25.

Each hinge unit 30 is formed with engagement grooves 32 each for movably receiving one elastic yoke 40.

In addition, each hinge unit 30 is formed with an engagement piece 34 which defines the engagement grooves 32 and is outwardly projected so as to prevent the corresponding elastic yokes 40 from escaping when the elastic yokes 40 are assembled.

Each engagement piece 34 is formed with notches 36 formed through the engagement piece 34 at the upper and lower portions of the engagement piece 34, so that the projections 45 of the elastic yokes 40 are projected through the notches 36 and come into contact with the corresponding catching portion 25 of the hinge locking pin 20.

Here, it is preferable if each of the left and right halves of the hinge locking pin 20 is provided with one hinge unit 30, and if the engagement grooves 32 and the engagement pieces 34 for assembling the elastic yokes 40 are formed in such a way that the engagement grooves 32 and the engagement piece 34 formed on one hinge unit 30 are faced to those formed on the other hinge unit 30.

The elastic yokes 40 are inserted and removably secured in the engagement grooves 32 of the hinge units 30 at the opposite sides of the hinge locking pin 20 as described above.

The elastic yokes 40 are provided in upper and lower engagement grooves in the left and right hinge units 30, respectively, so that the frictional force between the elastic yokes 40 and the catching portions 25 each formed on the left and right halves of the hinge locking pin 20 can be increased, whereby the closure of the glove box can be slowly pivoted when opened.

Each elastic yoke 40 is formed with a semi-circular projection 45 at the central part thereof, so that the projection 45 can be projected through a corresponding one of notches 36 formed through the engagement pieces 34.

The projection 45 of the elastic yoke 40 may be formed in a shape of a semi-oval as shown in FIG. 5a or in a shape of plural integrally formed semi-circles as shown in FIG. 5b.

The projection 45 of the elastic yoke 40 comes into contact with the corresponding catching portion 25 of the hinge locking pin 20 and the opposite legs 42 of the elastic yoke 40 are engaged with the opposite side walls of the corresponding engagement groove 32, respectively.

Therefore, when the hinge locking pin 20, which serves as the pivot axis of the glove box housing 10, is rotated as the glove box housing 10 pivots, the elastic yokes 40 provided in the hinge units 30 are gradually compressed and deformed as the projections 45 of the elastic yokes 40 approach the apexes of the oval shape of the catching portions 25, as shown in FIG. 6, whereby the relative contact force of the projections 45 of the elastic yokes 40 with the catching portions 25 and hence the frictional force between the projections 45 and the catching portions 25 can be increased.

That is, as can be seen from FIG. 7, which is a graph showing the relationship between the pivot angle of the glove box and the pivotal frictional force produced when the grove box pivots, because the additional pivot of the glove box increases the frictional contact area between projections 45 of the elastic yokes 40 and the catching portions 25 as compared with the initial pivot of the glove box, the pivotal frictional force is also increased in proportion to the pivot angle of the glove box.

As a result, when the closure of the glove box pivots, its pivot speed is controlled and reduced, so that the abrupt opening caused by the self-weight of the glove box can be prevented and thus the noise produced when the closure is opened can be also prevented.

The O-rings 50 can be inserted into the two insertion grooves 23 formed on the hinge locking pin 20, respectively.

In addition, the O-rings 50 are engaged with the opposite sides of the glove box housing 10, respectively (see FIG. 3).

Accordingly, the O-rings 50 prevent the generation of gap between the glove box housing 10 and the hinge locking pin 20 when the globe box housing 10 pivots.

That is, the O-rings 50 serve to prevent a gap from being produced when the oval catching portions 25 of the hinge locking pin 20 pivots through the rotational supports of the glove box housing 10.

Here, the O-rings 50 are preferably formed from an elastic silicon material so as to cope with various forms of gap produced when the glove box housing 10 pivots.

The operation of inventive hinge structure of a glove box for a vehicle configured as described above is now described below.

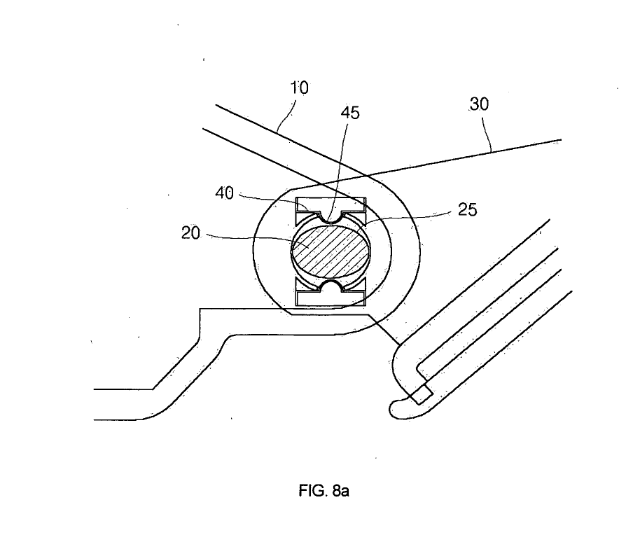

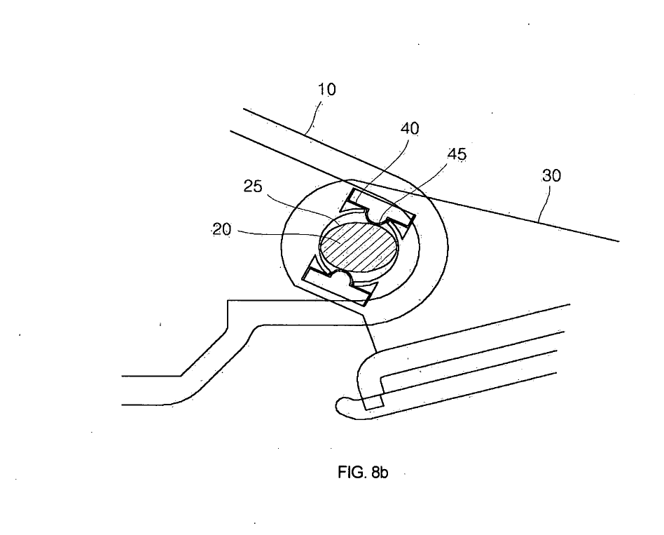

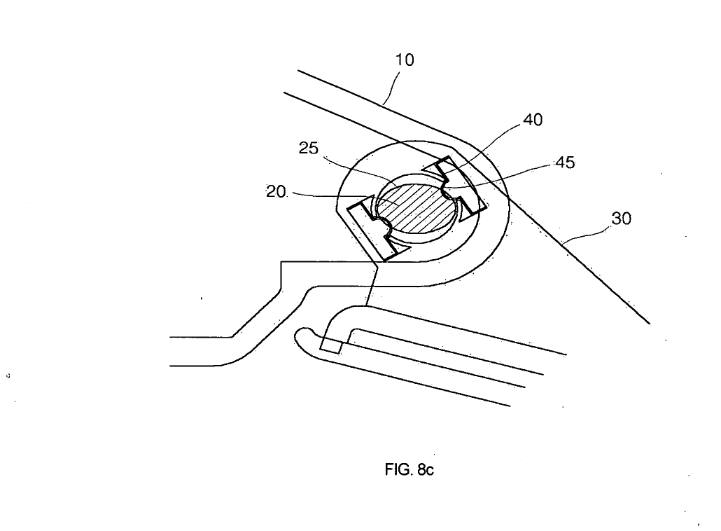

FIGS. 8a to 8c show the operation of the inventive hinge structure of a glove box for a vehicle.

At the initial state in which the closure of the glove box is closed, the elastic yokes 40 are positioned at the neutral portions of the oval catching portions 25, which are formed in a substantially slow curvature, as shown in FIG. 8a.

At this time, no frictional force is exerted between the elastic yokes 40 and the catching portions 25.

If a user manipulates the closure of the glove box so as to open the closure of the glove box from the above-mentioned state, the closure of the glove box pivots due to its self-weight.

When the closure is opened, until a predetermined length of time after the closure of the glove box started opening, the closure pivots relatively rapidly, and when the projections 45 of the elastic yokes 40 get into contact with the catching portions 25 and pivot while being fractioned with the catching portions 25, that is, when the closure pivots about twenty degrees as shown in FIG. 8b, the closure is then slowly opened.

The slow opening of the closure is more decelerated as the projections 45 of the elastic yokes 40 approach the apexes of the oval catching portions 25 and if the closure pivots about sixty degrees, the closure stops opening because the elastic yokes 40 are fully deformed and thus substantial frictional force is applied between the projections of the elastic yokes 40 and the catching portions 25.

That is, as the projections 45 of the elastic yokes 40 are engaged with the apexes of the oval catching portions 25 and the rotation of the closure of the glove box is stopped, the opening of the closure is completed.

With the inventive hinge structure of a glove box for a vehicle, it is possible to obtain effects as follows:

i) because a pivot speed control hinge system is employed without a separate air damper, the manufacturing costs can be saved;

ii) because a hinge locking pin is sufficient for assembling without an air damper, it is simple to assemble a glove box and the hinge structure thereof and the assemblability of the glove box can be enhanced;

iii) it is possible to substantially reduce or avoid the noise produced when an air damper is not employed, i.e., produced when the glove box pivots due to its self-weight; and

iv) it is possible to enhance the dignity and commercial value of a resultant article because as the pivot speed of the glove box can be controlled depending on the pivot angle of the glove box.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A hinge structure of a glove box for a vehicle comprising:
a grove box housing 10;
a hinge locking pin 20 assembled with the glove box housing 10 so as to serve as a pivot axis for the glove box housing 10, with the hinge locking pin 20 being provided with catching portions 25 each on left and right halves thereof;
a pair of hinge units 30 each fitted on the left and right halves of the hinge locking pin 20, in such a way that the glove box housing 10 can be hingedly intermitted by the hinge units 30; and
elastic yokes 40 inserted and removably secured in engagement holes 32 each formed in one of the hinge units 30.

2. A hinge structure as claimed in claim 1, wherein the hinge locking pin 20 has an escape prevention ridge 22 and a handle 24, at one end thereof, and a catching ridge 26 and a slit 28, at the other end.

3. A hinge structure as claimed in claim 1 or 2, wherein each hinge unit 30 is provided an engagement piece 34 and notches 36 are formed through the upper and lower portions of the engagement piece 34.

4. A hinge structure as claimed in claim 1, wherein the elastic yokes 40 are provided at upper and lower sides of the left and right halves of the hinge locking pin 20.

5. A hinge structure as claimed in claim 1 or 4, wherein each elastic yoke 40 has a projection 45 which is formed at the central part of the elastic yoke 40 in a shape of a semi-oval, a semi-circle, or plural integrally formed semi-circles, with the rear side of the projection being concavely formed in a corresponding shape.

6. A hinge structure as claimed in claim 1 or 4, wherein the elastic yokes 40 are movably engaged with the catching portions 25.

7. A hinge structure as claimed in claim 6, wherein each catching portion 25 is formed in an oval shape in cross-section.

8. A hinge structure as claimed in claim 1, further comprising O-rings 50 for preventing gap from being produced between the glove box housing 10 and the hinge locking pin 20 when the glove box housing 10 pivots.

9. A hinge structure as claimed in claim 8, wherein the O-rings 50 are formed from a silicon material.

10. A hinge structure as claimed in claim 8, wherein the O-rings 50 are provided at the opposite sides of the glove box housing 10, respectively.
